(19) United States
(12) Patent Application Publication
(10) Pub. No.: US 2001/0031115 A1
(43) Pub. Date: Oct. 18, 2001

(54) Device for coupling low numerical aperture light input high numerical aperture optical instruments

(76) Inventors: Chingfa Chen, West Covina, CA (US); Kenneth K. Li, Arcadia, CA (US); Douglas M. Brenner, Los Angeles, CA (US)

Correspondence Address: ROTHWELL, FIGG, ERNST & MANBECK, P.C., 555 13TH STREET, N.W., SUITE 701, EAST TOWER, WASHINGTON, DC, 20004, US

(21) Appl. No.: 09/761,862

(22) Filed: Jan. 18, 2001

Related U.S. Application Data
(63) Continuation of application No. PCT/US99/16546, filed on Jul. 23, 1999.
(60) Provisional application No. 60/094,109, filed on Jul. 24, 1998.

(51) Int. Cl. G02B 6/26; G02B 6/04; F21V 8/00

(52) U.S. Cl. 385/54; 385/43; 385/31; 385/117; 362/554

(57) ABSTRACT

An illumination system includes a light source and a tapered bundle of fused optical fibers having a light input end configured for receiving light, the light input end having a first cross sectional area and a first numerical aperture, the tapered bundle having an output end configured for outputting light, the output end having a second cross sectional area and a second numerical aperture. The bundle of fused optical fibers is tapered between the input end and the output end such that there is a difference in size between the first and second cross sectional areas, so that light exiting the output end has a higher numerical aperture. A first fiber optic light guide is coupled to the light source for receiving light from the light source and delivering light to the input end of the tapered bundle, or the light can be directly coupled into the tapered bundle. A second fiber optic light guide delivers light from the output end of the bundle through the second fiber optic light guide of the endoscope or other lighted instruments.

### BACKGROUND OF THE INVENTION

1. Field of the Invention

The present invention relates to the field of light coupling devices.

2. Description of the Background Art

The transmission of light from a light source to an endoscope or other lighted instrument, e.g. lighted retractor, is typically accomplished through a fiber optic bundle, comprised of thousands of individual fibers bundled together to form a larger diameter cable. The size of the bundle is usually determined by the characteristics of the light source coupled to the bundle and the amount of light required by the lighted instrument. An endoscope is used for purposes of illustration. The size of the fiber bundle inside of the endoscope is determined both by the amount of light required and the available space inside an endoscope. For small diameter endoscopes, the amount of space available for the fiber bundle results in an internal fiber bundle having a diameter that is smaller than the diameter of the light delivery fiber bundle. Therefore, illumination of the endoscope does not fully utilize the available light output. This mismatch in size reduces efficiency and produces unwanted heat at the endoscope.

In addition to the total light delivered to an endoscope, another consideration is matching the field of view to the angle of illumination. The typical numerical aperture (NA) of the fibers used in the light delivery bundle is 0.55 while that of the internal fiber bundle to an endoscope is typically 0.66, although wide-angle endoscopes greater than 80 degrees typically incorporate fiber bundles with a numerical aperture of 0.8 or higher, thereby providing adequate light to the peripheral area of the image field of the endoscopes. When the light of a lower numerical aperture from a fiber bundle is introduced into the higher numerical aperture illumination fibers inside the endoscope, the light does not fully excite all of the available modes in the high numerical aperture fiber, especially the higher order modes. This results in a narrower illumination field at the output of the endoscope than desired, uneven illumination in the field of view with excessive illumination at the central portion of the image field and inadequate illumination at the periphery. Therefore, there is a need to convert the smaller NA input light from the fiber cable into the larger NA output light at the end of the illumination fibers.

The following have been used to convert the smaller NA of the input light profiles into the larger NA output illumination profiles at the end of endoscope:

use of a glass cone or tapered cladded rod 1 at the input end of the scope as in FIG. 1, including a large diameter fiber bundle 2 and a smaller diameter fiber bundle 3 in an endoscope.

use of lenses to focus light into large angle at the input of the scope.

use of a negative lens at the output of the scope to spread the beam.

arranging the illumination fibers inside the endoscope in a helical manner to spread the beam.

U.S. Pat. No. 4,953,937 describes the coupling of light from a fiber bundle to the input of endoscopic illumination fibers by inserting between the bundle and the endoscope input an optical system to modify the output profile of the input fiber bundle to provide a flatter and/or wider field of illumination at the output of the endoscope. The optical systems of U.S. Pat. No. 4,953,937 include the following in various combinations: positive lenses of various shapes and focal lengths, lenses with cladded perimeters, cladded rods, positive lenses with fresnel lens surfaces, and tapered light guides with lenses.

U.S. Pat. Nos. 4,576,435 and 4,483,585 disclose a “pipe-shaped” reflector (tapered or non-taper clad rod) to be attached to the input endface of the illumination fibers. The intensity profile of the light distribution from the output of the lamp is spread out and the peak intensity is reduced at the input endface of the illumination fibers to reduce the possibility of burning the fiber bundle.

U.S. Pat. No. 4,747,660 proposes inserting an angled cladded rod with various endface configurations at the focus of the lamp. It produces an output angular distribution that has a higher output at larger angles than along the axis. A simple optical wedge can also be used to achieve the same result.

U.S. Pat. No. 4,584,988 uses a specially shaped end piece and special lens system attached to the distal endface of the illumination fibers to provide a wider angle of illumination.

U.S. Pat. No. 3,874,783 describes increasing the numerical aperture by coupling together two fiber bundles asymmetrically with respect to their axes. This effectively increases the input angle at the endface of the receiving fiber bundle, thus increasing the output angle of the second bundle. Same effect can be achieved by aligning the input and output fiber bundles in such a way that the normals of two endfaces form an angle θ>0. However, with respect to prior attempts to couple light into endoscopes, the use of a glass cone or cladded rod (both tapered and non-tapered) at the input endface of the endoscope's illumination channel tends to have low light efficiency and produces non-uniformity in the illuminated field. Lens systems tend to be bulky, high cost and difficult to align. The helical layout configuration of illumination fibers around an optical channel is difficult to make and would not work if the distribution of the illumination fibers inside the endoscope is not annular. The negative lens at the distal end of the scope is expensive and is difficult to manufacture for the smaller endoscopes. Moreover, the efficiency of any the optical methods for transforming the numerical aperture of the input light to the endoscope is decreased by the large mismatch in area between the light delivery bundle and the endoscopic internal bundle.

There remains a need in the art for improved endoscope and lighted instrument illumination systems.

### SUMMARY OF THE INVENTION

In accordance with the present invention, an illumination system comprises a fiber optic light source and a tapered optical fused bundle having a light input end for receiving light from the fiber optic connected to the light source and an output end for transmitting light to a fiber bundle or single fiber integral to a lighted instrument. The input end of the tapered fused bundle is of similar dimensions as the fiber optic from the light source, typically less than or equal to 2 mm diameter, and the output end of the tapered fused bundle is of similar dimensions as the fiber bundle or single fiber integral to the lighted instrument, such as an endoscope, and for this invention generally not requiring more than a 1.5 mm diameter in any lighted instrument. The tapered fused bundle, which may be internal or external to the lighted instrument, has a light input end having a first cross sectional area and a first numerical aperture, an output end having a second cross sectional area and a second numerical aperture wherein the first cross sectional area is larger than the second and the first numerical aperture is smaller than the second. The optical fused bundle is tapered between said input end and said output with a taper angle so as both to optimize the change in numerical aperture to match that of the bundle or single fiber inside the lighted instrument and to minimize light loss. The light emerging from the output end of the tapered bundle has a substantially larger numerical aperture than the input end of the tapered fused bundle. This illumination system is applicable to endoscopes and other lighted instruments.

### BRIEF DESCRIPTION OF THE DRAWINGS

FIG. 1 is a schematic drawing showing prior art coupling of output of a fiber bundle to the input of an endoscope using a prior art glass cone or tapered rod.

FIG. 2a is a schematic diagram showing coupling light from a single fiber with small numerical aperture into an endoscope using a tapered fused bundle in accordance with the present invention.

FIG. 2b is a schematic diagram showing a first cross-sectional area of the tapered fused bundle shown in FIG. 2a.

FIG. 2c is a schematic diagram showing a second cross-sectional area of the tapered fused bundle shown in FIG. 2a.

FIG. 3 is a schematic diagram showing coupling of light from a fiber bundle into a single fiber using a tapered fused bundle with a truncated output and with a further increase in output numerical aperture.

FIG. 4 shows a graphic comparison of the output profile between a glass cone and a tapered fused bundle in accordance to the present invention. These are intensity profiles across the diameter showing the variations in one dimension which indicates non-uniformities in two dimensions for the cladded rod case.

FIG. 5a is a graph depicting an output profile comparison of a 0.66 NA fiber bundle with various taper ratios, wherein the taper ratio equals the input end face diameter over the output end face diameter of the tapered fused bundle, with curve 104 representing a taper ratio of 1, curve 106 representing a taper ratio of 1.18, curve 108 representing a taper ratio of 1.52, and curve 110 representing a taper ratio of 1.63.

FIG. 5b is a graphic depiction of an endoscope illumination intensity comparison showing output profiles of a typical endoscope with and without a tapered fused bundle at the input, wherein curve 112 shows an endoscope without a tapered fused bundle, and curve 114 shows an endoscope with a tapered fuse bundle.

FIG. 6 schematically illustrates an off-axis illumination system for use in accordance with one embodiment of the present invention.

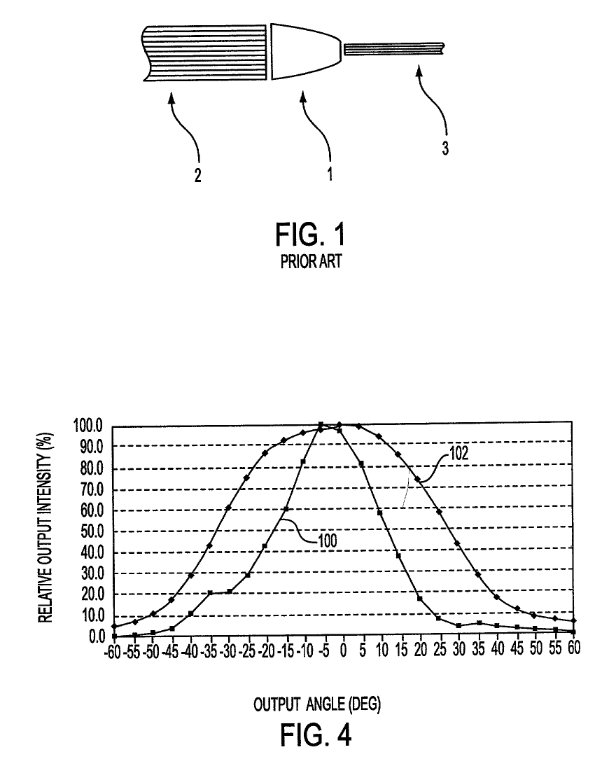

### DETAILED DESCRIPTION OF THE INVENTION

The present invention relates to the efficient coupling between two light-transmitting fiber optic light guides with different numerical apertures, one for light delivery from a light source and the other internal to a lighted instrument such as an endoscope. Particularly, the invention relates to the increase of the numerical aperture of the input light to match the numerical aperture of the output fiber(s).

This invention is directed to the optical system of converting low numerical aperture light into high numerical aperture light with high efficiency, particularly for providing illumination to endoscopes, boroscopes and lighted instruments which include retractors, laryngoscopes, speculums, cannulas, suction cannulas, and irrigation cannulas, with large numerical aperture illumination fibers. The result is a wider, more uniformly illuminated field of view derived from the output of the fused bundle characterized by a larger numerical aperture than that of the fiber optic light delivery system.

The present invention is applicable to a fiber bundle or a single fiber connected to a light source in which the fiber optic light guide may be made of quartz, borosilicate glass, or plastic. The following description is illustrative of the invention and is applied to the illumination system to an endoscope.

A short tapered fused fiber bundle is used to transform the output of a lower numerical aperture light input into a higher numerical aperture light output. The transformation of input and output numerical apertures can be closely described by the formula

DᵢNAᵢ=DₒNAₒ

where Dᵢ is the diameter of the said input cross section of the said tapered fused bundle and NAᵢ is the numerical aperture of the light coupled into the input endface of tapered fused bundle. Dₒ is the diameter of the said output cross section of the said tapered fused bundle and NAₒ is the numerical aperture of the output light emerging from the said output cross section of the said tapered fused bundle. The numerical aperture of the said output light can be further increased by the angle of the truncated output end. The eventual peak intensity of the output light from the endoscope using said tapered fused bundle is further reduced by the fiber-to-fiber cross coupling and the coupling between the guided modes in the fiber and the unguided modes between the fibers while the light is propagating along the tapered fused bundle. The tapered fused bundles produces less variation in the output intensity profiles of the endoscope compared to prior art tapered cladded rods or glass cones, and lower cost and easier assembly compared to using prior art lenses.

The diameter of the single fiber or fiber bundle light guide connected to the light source is equal to Dᵢ and is typically 2-mm or smaller. The transformation of the numerical aperture into a uniform output is facilitated by Dᵢ≦2 Dₒ and the diameter of the fibers of the tapered fused bundle being less than 0.1 Dₒ. The small diameter of the fibers in the fused bundle enables an adiabatic transition from NAᵢ to NAₒ over a short distance at high efficiency.

The present invention is particularly useful in the endoscope in which the diameter of the input endface of the illumination fibers is small and the numerical aperture of the illumination fiber is large. In the preferred embodiment, the illumination fiber has a diameter of 2 mm or less and tapered down to even smaller diameter thus allowing the use of a very small number of high NA fiber in the endoscope, reducing the overall size of the endoscope.

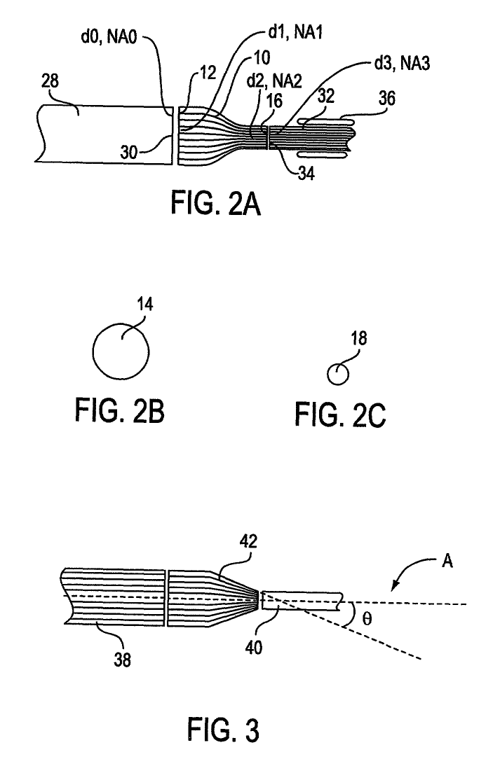

FIG. 2a shows an embodiment in accordance with one aspect of the present invention including a tapered bundle of fused optical fibers 10, configured for receiving light from the input single illumination fiber 28 with cross sectional area d0 and a numerical aperture NA0 at end 30. The fused optical fiber is made by fusing a bundle of individual fibers with smaller diameters and can be made into many geometric shapes. In this embodiment, the fused optical fiber bundle is circular in cross section and the individual fibers of the fused bundle have a diameter smaller than 100 μm. The smaller the diameter of the fibers and the larger the number, the greater degree of mode mixing and uniformity at the output end of the taper.

The light input end 12 has a first cross sectional area d1 (14 shown in FIG. 2b) and a first numerical aperture NA1. The tapered bundle 10 also has an output end 16 configured for outputting light. The output end 16 has a second cross sectional area d2 (18 shown in FIG. 2c) and a second numerical aperture NA2. The taper angle between d1 and d2 determines the efficiency of light transmission. To produce a high numerical output, it is necessary that d1 be larger than d2 resulting in NA1 smaller than NA2. For the tapered fused optical fiber bundle 10 to guide light to the output with numerical aperture NA2, the numerical aperture of the material of the tapered bundle of fused optical fiber 10 has to be at least equal to NA2.

By utilizing a tapered optical fused bundle in accordance with the present invention, light exiting the output end 16 has a substantially uniform output across substantially all of the second cross sectional area 18 and a larger numerical aperture. This is in contrast to prior art that makes use of a tapered cladded rod or cone for which the light output is typically a ring pattern because of insufficient mode mixing. The output from the tapered optical fused bundle 10 is coupled into the second fiber optic 32, e.g., a microbundle in an endoscope, with input cross sectional area d3 and a numerical aperture NA3. The second fiber optic 32 can either be a single fiber of a fiber bundle depending on the application. In one embodiment where high power is desired, the input end 34 of the second fiber optic bundle 32 is made without epoxy. When epoxy is used, it will absorb the light and generate enough heat to melt and burn and is only applicable when low power is utilized.

The invention permits use of tapered fused fiber bundle for transforming the light from one area/NA combination into another area/NA combination, resulting in a higher output angle of illumination as shown in FIG. 2a.

To make advantageous use of the invention, an efficient light source for coupling light into a fiber optic light guide 2-mm diameter or smaller is desirable. Particularly preferred is a light source which is close to a 1:1 imaging system. The off-axis systems of U.S. Pat. Nos. 4,757,431, 5,430,634, and 5,414,600 or the on-axis system of U.S. Pat. No. 5,509,095 accomplishes this requirement. Such systems require a short arc gap and can be configured with a variety of lamps including xenon, metal halide, halogen, mercury, and mercury-xenon. The transformation of the area/NA requires a minimum length depending on the diameter of the input fiber which determines the diameter of the input of the optical taper, which can be a fused bundle (current invention) or a cladded rod (prior art). A tapered fused bundle advantageously is comprised of individual fibers typically less than 100 microns in diameter. Thus the area/NA transformation takes place in a relatively short distance, approximately 10 times the diameter of the individual fiber or 1 mm. For a tapered cladded rod, the length of the taper must be at least 10 times the input diameter, requiring for a 2-mm input at least a 20 mm length. A length shorter than this results in larger taper angle, higher light loss, and insufficient mode mixing leading to a non-uniform output.

In preferred embodiments, the illumination system is an off-axis illuminator as shown schematically in FIG. 6 and described in U.S. Pat. Nos. 4,757,431, 5,414,600 and 5,430,634, incorporated herein by reference. As shown in FIG. 6, an off-axis illuminator includes a light source 20, which may be a xenon lamp or a short arc metal halide lamp. Lamp 20 illuminates a mirror 22 having an axis 24. Light from source 20 is reflected from mirror 22 onto a target 26 which is off-axis with respect to mirror axis 24. Target 26 can be, for example, the end of a single core optic fiber such as single fiber 28 shown in FIG. 2a, or the tapered optical fused bundle.

Fiber 28 shown in FIG. 2a is a first fiber optic light guide for receiving light from the light source and delivering light to the input end 12 of the tapered bundle 10. The first fiber optic light guide 28 can be a plastic fiber of different sizes for different applications. Alternatively, the fiber 28 can be a quartz fiber, a borosilicate fiber, or a fiber bundle of plastic, quartz, or borosilicate fibers.

An illumination system in accordance with the present invention includes a second fiber optic light guide 32 having an end 34 for receiving light from the output end 16 of tapered bundle 10 and delivering light from the output end 16 of the tapered bundle to the endoscope 36.

FIG. 3 shows a first fiber optic light guide 38 which is an input bundle comprising a plurality of fibers, substituted for the single input fiber 28 shown in FIG. 2a.

FIG. 3 also shows a single fiber 40 as the second fiber optic light guide, instead of a bundle comprising a plurality of fibers 32 as shown in FIG. 2a.

Also shown in FIG. 3 is a truncated cone tapered fused fiber bundle 42 in accordance with one embodiment of the present invention. The truncation refers to the diameter at the output end of the fused bundle which is not uniform, but is still decreasing at the output end. In the truncated fused bundle embodiment shown in FIG. 3, the conical angle θ with respect to axis A is greater than 0°.

In other embodiments, a single fiber input 28 as shown in FIG. 2a can be utilized with a truncated cone 42 as shown in FIG. 3 and a micro-bundle 32 or single fiber output 40, or the tapered fused bundle 10 shown in FIG. 2a can be utilized with an input fiber bundle 38 and a micro-bundle 32 or single fiber output 40.

In accordance with preferred embodiments, fiber 28 as well as fiber bundle 38, have the smaller numerical aperture, and the fibers of micro-bundle 32, and fiber 40 have the larger numerical aperture, i.e. NA3 is larger than NA0.

In preferred embodiments, the tapered fused bundle 10 is made with fibers having a diameter of smaller than 100 μm.

As shown in FIG. 2a, in accordance with preferred embodiments, end 30 of the first fiber 28 has an end size of the same or smaller than the input end 12 of fused bundle 10 (d0 is less or equal to d1), and the output end 16 of fused bundle 10 has a size of the same or smaller than the end 34 of bundle 32 (d2 is less or equal to d3).

The tapered fused bundle produces an output angular profile that has a substantially continuous and smooth profile. In contrast, the prior art tapered cladded rod produces rings and swirls. These rings and swirls transmit through the endoscope illumination bundle and show up as non-uniformity in the field of view, as shown in FIG. 4, wherein curve 100 is the output intensity profile of a 0.66 NA tapered glass cone with a 0.5 NA fiber cable input and curve 102 is the output intensity profile of a 0.66 NA tapered fused bundle with a 0.5 NA single fiber input.

In the preferred embodiment, the length of the tapered fused fiber bundle is long as compared to the size of the individual fibers inside the bundle.

The output intensity profile of the tapered fused bundle is controlled by the numerical aperture of the input light, and/or the numerical aperture of the fused bundle, and the taper ratio which is represented by the area ratio of the output to the input ends. The exact output intensity profile is also dependent on the individual fiber size, and the fiber cladding thickness in the fiber bundle, as well as the degree of the cross-coupling between the individual fibers. In the preferred embodiment, the numerical aperture NA0 of fiber 28 is equal or less than the numerical aperture NA1 of the input of the fused bundle 10 and the numerical aperture NA2 of the output of the fused bundle 10, is substantially equal to the numerical aperture of the second fiber 32. These arrangements allow substantially optimum coupling of power from the input to the output.

In another embodiment, for further increasing the uniformity of the output by overfilling, the cross sectional area d0 of the input fiber 28 is equal to or larger than the input cross sectional area d1 of the fused bundle 10, and the output cross sectional area d2 of the fused bundle 10 is equal to or larger than the input cross sectional area d3 of the output fiber 32. At the same time, the numerical aperture NA0 of the input fiber 28 is equal to or larger than the numerical aperture NA1 of the input of the fused bundle 10, and the numerical aperture NA2 of the output of the fused bundle 10 is equal to or larger than the numerical aperture NA3 of the second fiber 32.

The invention is further illustrated by the following Examples, which are not intended to be limiting.

### EXAMPLE 1

Experiments were performed using straight cladded rod, tapered cladded rod, straight fused fiber bundle, and tapered fused fiber bundle. They were illuminated with a fiber smaller than the diameter of the device, similar to a point source, wherein the diameter was about the same as the input diameter, and illuminated with a fiber bundle with diameter larger than the device, to simulate an extended source.

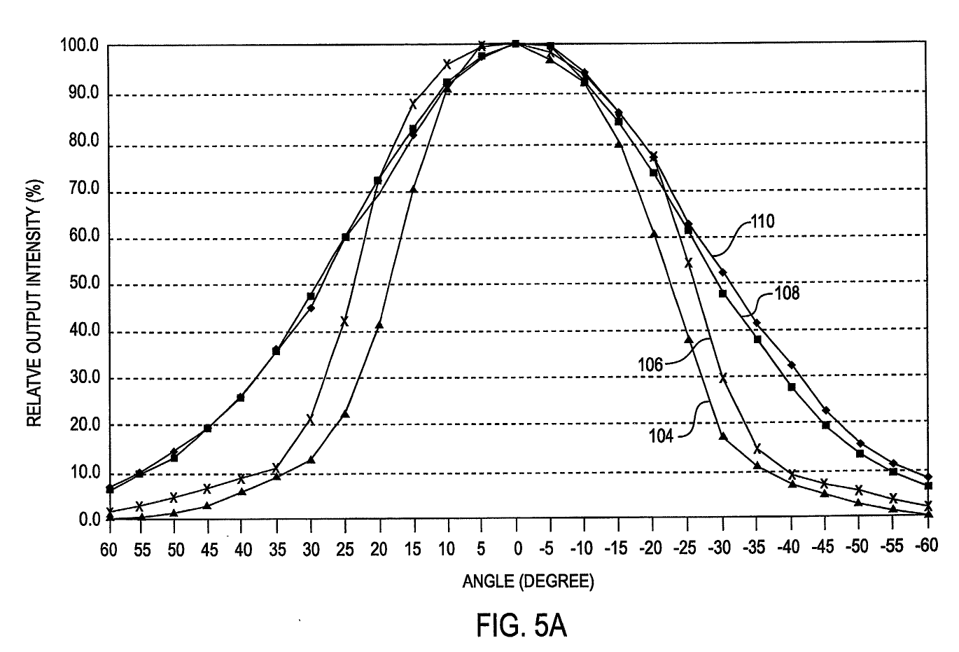

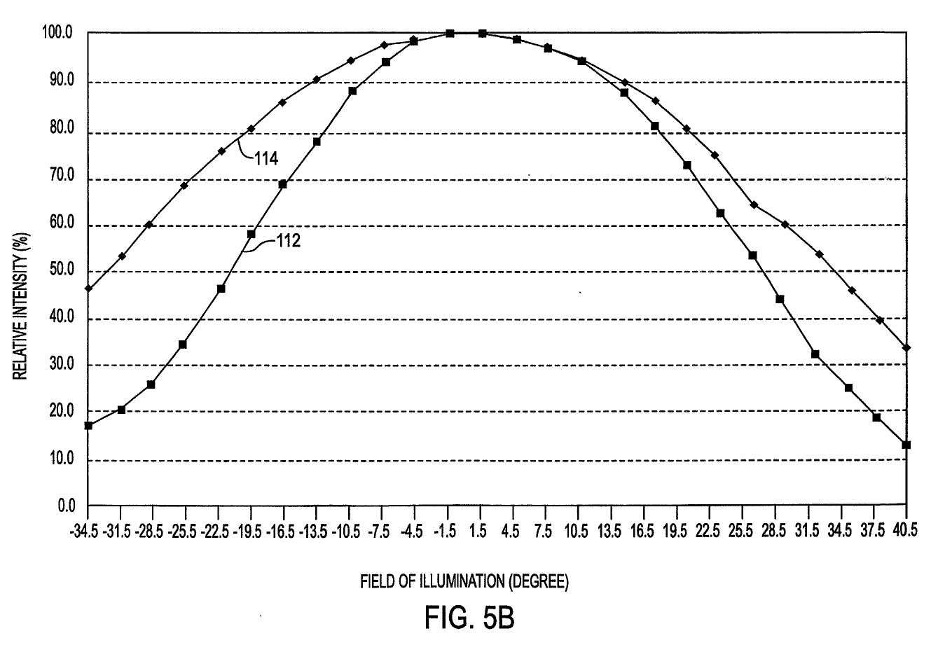

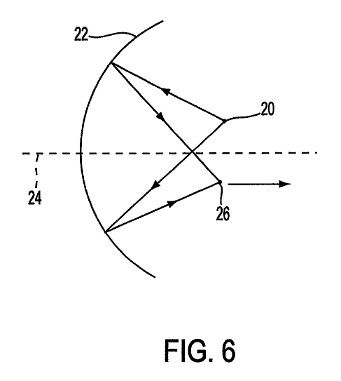

In all cases, the output from the straight and tapered fused fiber bundle gave a substantially continuous smooth field. On the other hand, the output from the straight and tapered cladded rod gave a varying and non-uniform output field. The non-uniformity of the output from the cladded rod has been shown to pass from the input of a scope or fiber bundle to the output which is not desirable for endoscopic applications. Furthermore, the numerical aperture of the output of the tapered fused bundle was related to the taper ratio as shown in FIGS. 5a, and 5b.

As a result, the output illumination profile can be controlled by utilizing this ratio. On the other hand, the numerical aperture of the output using a prior art tapered cladded rod does not follow the taper ratio, especially on rods that have length in the practical range. Instead, most of the light from the input transmitted to the output directly without reflection from the taper, thus defeating the purpose of the taper for NA transformation. As a result, the output NA was smaller than desired.

### EXAMPLE 2

A single fiber illuminator was utilized with an off-axis illuminator coupling system as described in U.S. Pat. Nos. 4,757,431, 5,414,600 and 5,430,634. The color temperature was about 6,000K. Output to a 1.5 mm plastic fiber was about 1.5 W to 2.5 W. A 1.5 mm plastic fiber with a 0.5 NA was coupled to the arc of the lamp through a length of fused fiber bundle in accordance with U.S. patent application Ser. No. 08/927,092, incorporated herein by reference. The plastic fiber had a length of about 10 feet and was packaged sterilized for single use or was re-sterilizable.

A 0.66 NA fused fiber bundle was utilized, with the output diameter of the fused fiber bundle tapered approximately 33% in diameter to its input end. Individual fiber size was about 30 μm with cladding of about 3 μm. Alternatively, the exit end of the tapered fuse fiber bundle was truncated at an angle so that the output NA was made larger than the NA of the fused bundle. At a taper ratio of 1 to 1.5, an output NA of better than 0.75 has been observed, with an overall efficiency greater than 60% comparing light intensity input to the output through the tapered fused bundle.

The invention permits changing of the NA as needed. For example, for a wider output numerical aperture, a larger input numerical aperture input or a larger taper ratio can be utilized.

Light is transmitted from the tapered fused fiber bundle to an illumination channel of the endoscope. It is typically comprised of a small number of high numerical aperture fibers with a diameter on the order of 50 μm wrapped around the imaging channel of an endoscope in accordance with U.S. Ser. No. 08/725,480, incorporated herein by reference. At the input end of the endoscope, the fibers are bundled together to form a small bundle with the matching diameter to the tapered end of the fused fiber bundle. In the preferred embodiments, the input end of the illumination channel is prepared so that there is no glue or epoxy on the input endface for the high input power applications. For low power application, an endoscope input bundle with epoxy can be utilized. The light inputting to this fiber bundle comes from the output end of the tapered fused bundle in which the input end is coupled to the light source either directly or through a fiber.

1. An illumination system for minimizing the cross sectional area required for delivery of high intensity light to a lighted instrument and for maximizing the uniformity of the illuminated field, said system comprising:
a first fiber optic light guide having a cross sectional area d0 and a numerical aperture NA0, and an input end and an output end, wherein said input end is connected to a light source;
a tapered bundle of fused optical fibers having a light input end juxtapositioned to said output end of said first fiber optic light guide for receiving light from said output end of said first fiber optic light guide, the light input end having a first cross sectional area d1 and a first numerical aperture NA1, said tapered fused bundle having an output end configured for outputting light, the output end having a second cross sectional area d2 and a second numerical aperture NA2, wherein said bundle of fused optical fibers is tapered between said input end and said output end such that said first cross sectional area is greater than said second cross sectional area;
a second fiber optic light guide having a cross sectional area d3 and a numerical aperture NA3, and attached to a lighted instrument with an input end and an output end, wherein said input end of said second fiber optic light guide is juxtapositioned to said output end of said fused bundle for receiving light from said fused bundle juxtapositioned to said first fiber optic light guide, wherein said second fiber optic light guide transmits light to said output end of said second fiber optic light guide of said lighted instrument.

2. The system of claim 1 wherein the light source is selected from the group consisting of xenon, metal halide, halogen, mercury, and mercury-xenon light sources.

3. The system of claim 1 wherein said lighted instrument to which is attached said second fiber optic light guide is selected from the group consisting of endoscopes, borescopes, retractors, laryngoscopes, speculums, cannulas, suction cannulas, and irrigation cannulas.

4. The system of claim 1 wherein said first fiber optic light guide is selected from the group consisting of a single quartz fiber, a single plastic fiber, a plurality of quartz fibers, a plurality of glass fibers, and a plurality of plastic fibers.

5. The system of claim 1 wherein said cross sectional area d3 is not greater than said cross sectional area d2.

6. The system of claim 1 wherein said cross sectional areas of said first fiber optic light guide, said fused bundle, and said second fiber optic light guide are related by d0 at least equal to d1, d1 greater than d2, and d2 at least equal to d3.

7. The system of claim 1 wherein the numerical aperture of the material of the fused bundle is at least equal to said second numerical aperture NA2.

8. The system of claim 1 wherein said numerical apertures are related by a relationship NA0 is at least equal to NA1, NA1 is less than NA2, and NA2 is at least equal to NA3.

9. The system of claim 1 wherein said first fiber optic light guide has a diameter of 2 mm or less.

10. The system of claim 1 wherein the first numerical aperture is smaller than the second numerical aperture.

11. The system of claim 1 wherein the diameter of output end of the first fiber optic light guide is equal to or smaller than the input end of the tapered bundle of fused optical fiber.

12. The system of claim 1 wherein the first cross sectional area of the tapered bundle of fused optical fiber is larger than the second cross sectional area.

13. The system of claim 1 wherein said second fiber optic light guide is selected from the group consisting of a single fiber and a plurality of fibers.

14. The system of claim 1 wherein the diameter of the output end of the tapered bundle of fused optical fiber is equal to or smaller than the input end of the second fiber optic light glide.

15. The system of claim 1 wherein the numerical aperture of the second fiber optic light guide substantially equal to the numerical aperture of the output end of the tapered bundle of fused optical fibers.

16. The system of claim 1 wherein said numerical aperture of said output end of said tapered fused bundle is at least equal to said numerical aperture of said second fiber optic light guide to maximize the output uniformity of said lighted instrument.

17. The system of claim 1 wherein said second light guide comprises a plurality of fibers wherein said input end is free of adhesives.

18. The system of claim 1 wherein said tapered fused bundle comprises fibers having diameters of smaller than 100 μm.

19. The system of claim 1 wherein said input end and output end of said tapered fused bundle are circular in cross section.

20. The system of claim 1 wherein said tapered fused bundle is truncated at the output end such that the output end is conical in shape.

21. The system of claim 20 wherein the conical output end has a conical angle of greater than 0°.

22. The system of claim 1 further comprising a light collecting and condensing system between the light source and the first light guide.

23. An endoscope illumination system for maximizing output and uniformity at an illuminated field comprising:
a first fiber optic light guide having a cross sectional area d0 and a numerical aperture NA0 having an input end and an output end, wherein said input end is connected to a light source;
a tapered fused bundle having an input end with area d1 and numerical aperture NA1 and an output end with area d2 and numerical aperture NA2 such that NA2 is larger than NA1 and d2 is smaller then d1, wherein said input end is coupled to the output end of said first fiber optic;
a second fiber optic light guide for positioning inside an endoscope having an input end and an output end with numerical aperture NA3 and area d3, wherein said input end of the second fiber optic is coupled to the output end of the tapered fused fiber bundle.

24. The endoscope illumination system of claim 23, wherein the area d0 is smaller than or equal to d1.

25. The endoscope illumination system of claim 23, wherein the area d2 is smaller than or equal to d3.

26. The endoscope illumination system of claim 23, wherein numerical apertures NA0 and NA1 are substantially equal.

27. The endoscope illumination system of claim 23, wherein numerically apertures NA2 and NA3 are substantially equal.

28. The endoscope illumination system of claim 23, wherein the first fiber optic light guide is a plastic fiber.

29. The endoscope illumination system of claim 23, wherein the second fiber optic light guide is a bundle of fibers.

30. The endoscope illumination system of claim 23, wherein said first fiber optic light guide has a circular cross section of a diameter not greater than about 2 mm.

31. The endoscope illumination system of claim 23, wherein said output end of said tapered fused bundle transmits at least about 60% of light received by said input end of said tapered fused bundle to said second fiber optic light guide.
